(19) United States
(12) Patent Application Publication
(10) Pub. No.: US 2015/0127313 A1
(43) Pub. Date: May 7, 2015

(54) Method For Determining The Presence and Location of A Subsurface Hydrocarbon Accumulation and The Origin of The Associated Hydrocarbons

(71) Applicants: Michael Lawson, Houston, TX (US); Sebastien L. Dreyfus, Houston, TX (US); Sumathy Raman, Annandale, NJ (US); Robert J. Pottorf, Houston, TX (US); Steve R. May, Missouri City, TX (US)

(72) Inventors: Michael Lawson, Houston, TX (US); Sebastien L. Dreyfus, Houston, TX (US); Sumathy Raman, Annandale, NJ (US); Robert J. Pottorf, Houston, TX (US); Steve R. May, Missouri City, TX (US)

(73) Assignee: EXXON-MOBIL, UPSTREAM RESEARCH COMPANY, Houston, TX (US)

(21) Appl. No.: 14/350,911

(22) PCT Filed: Aug. 27, 2012
(86) PCT No.: PCT/US12/52542

§ 371 Date: Apr. 10, 2014

Related U.S. Application Data
(60) Provisional application No. 61/558,822, filed on Nov. 11, 2011.

(51) Int. Cl. G01V 9/00; E21B 43/16

(52) U.S. Cl. CPC G01V 9/007; E21B 43/16
USPC 703/10

(57) ABSTRACT

A method of determining a presence and location of a subsurface hydrocarbon accumulation from a sample of naturally occurring substance. An expected concentration of isotopologues of a hydrocarbon species is determined. An expected temperature dependence of isotopologues present in the sample is modeled using high-level ab initio calculations. A clumped isotopic signature of the isotopologues present in the sample is measured. The clumped isotopic signature is compared with the expected concentration of isotopologues. Using the comparison, it is determined whether hydrocarbons present in the sample originate directly from a source rock or whether the hydrocarbons present in the sample have escaped from a subsurface accumulation. The current equilibrium storage temperature of the hydrocarbon species in the subsurface accumulation prior to escape to the surface is determined. A location of the subsurface accumulation is determined. This information may be integrated with pre-drill basin burial history models to calibrate a basin model.

### CROSS-REFERENCE TO RELATED APPLICATION

This application claims the benefit of U.S. Provisional Patent Application 61/558,822 filed Nov. 11, 2011 entitled METHOD FOR DETERMINING THE PRESENCE AND LOCATION OF A SUBSURFACE HYDROCARBON ACCUMULATION AND THE ORIGIN OF THE ASSOCIATED HYDROCARBONS, the entirety of which is incorporated by reference herein.

### FIELD OF THE INVENTION

Embodiments of the present disclosure relate generally to the field of geochemistry. More particularly, the present disclosure relates to systems and methods for determining the origin and storage temperature (and hence depth) of subsurface hydrocarbon accumulations.

### BACKGROUND

This section is intended to introduce various aspects of the art, which may be associated with exemplary embodiments of the present disclosure. This discussion is believed to assist in providing a framework to facilitate a better understanding of particular aspects of the present invention. Accordingly, it should be understood that this section should be read in this light, and not necessarily as admissions of prior art.

The major components required for the presence of subsurface hydrocarbon accumulations in a sedimentary basin are (1) the generation and expulsion of liquid hydrocarbons from a source rock, (2) migration of liquid hydrocarbons to and accumulation in a reservoir, (3) a trap and a seal to prevent significant leakage of hydrocarbons from the reservoir.

At present, reflection seismic is the dominant technology for the identification of hydrocarbon accumulations. This technique has proved successful in identifying structures that may host hydrocarbon accumulations, and in some cases have been used to image the hydrocarbon fluids within subsurface accumulations. However, in some cases this technology lacks the required fidelity to provide accurate assessments of the location of subsurface hydrocarbon accumulations due to poor imaging of the subsurface. Additionally, it is not easy to differentiate the presence and types of hydrocarbons from other fluids in the subsurface by remote measurements.

Current non-seismic hydrocarbon detection technologies do not significantly improve our ability to identify the location of a hydrocarbon accumulation. For example, seepage of hydrocarbons at the sea floor or on land provides some indication of an active or working hydrocarbon system where hydrocarbons have been generated and expulsed during the thermal maturation of a source rock at depth, and have migrated via more or less complex migration pathways to the surface. However, it is difficult from current non-seismic technologies to determine whether such hydrocarbon seepages migrated directly from a source rock or from a hydrocarbon accumulation, and it is not possible to locate subsurface accumulations associated with seeps.

As such, there is a need for additional techniques that can more effectively detect the presence and the location of hydrocarbon accumulations in the subsurface. In particular, a relatively inexpensive and rapid method for determining the presence and location of a subsurface hydrocarbon accumulation and the origin of the associated hydrocarbons (i.e. source facies and thermal maturity of the source rock that have generated these hydrocarbons) would provide a valuable tool that could be used in hydrocarbon exploration at all business stage maturity levels, from frontier exploration to extension of proven plays or high-grading prospects in proven plays.

### SUMMARY

According to disclosed aspects and methodologies, a system and method are provided for estimating/determining the equilibrium residence temperature of hydrocarbon samples.

According to disclosed aspects and methodologies, a method of determining a presence and location of a subsurface hydrocarbon accumulation from a sample of naturally occurring substance is disclosed. According to the method, an expected concentration of isotopologues of a hydrocarbon species is determined. An expected temperature dependence of isotopologues present in the sample is modeled using high-level ab initio calculations. A clumped isotopic signature of the isotopologues present in the sample is measured. The clumped isotopic signature is compared with the expected concentration of isotopologues. Using the comparison, it is determined whether hydrocarbons present in the sample originate directly from a source rock or whether the hydrocarbons present in the sample have escaped from a subsurface accumulation. The current equilibrium storage temperature of the hydrocarbon species in the subsurface accumulation prior to escape to the surface is determined. A location of the subsurface accumulation is determined.

Also according to disclosed methodologies and techniques, a method of determining a presence and location of a subsurface hydrocarbon accumulation is provided. According to the method, a hydrocarbon sample is obtained from a seep. The hydrocarbon sample is analyzed to determine its geochemical signature. The analyzing includes measuring a distribution of isotopologues for a hydrocarbon species present in the hydrocarbon sample. A stochastic distribution of the isotopologues for the hydrocarbon species is determined. A deviation of the measured distribution of isotopologues from the stochastic distribution of the isotopologues for the hydrocarbon species is determined. The origin of the hydrocarbon sample is determined. A storage temperature of the hydrocarbon species is determined when the origin of the hydrocarbon sample is a hydrocarbon accumulation. From the storage temperature, the location of the hydrocarbon accumulation is determined.

According to methodologies and techniques disclosed herein, a method is provided for determining a presence of a subsurface hydrocarbon accumulation from a sample of naturally occurring substance. According to the method, an expected concentration of isotopologues of a hydrocarbon species is determined. An expected temperature dependence of isotopologues present in the sample is modeled using high-level ab initio calculations. A clumped isotopic signature of the isotopologues present in the sample is measured. The clumped isotopic signature is compared with the expected concentration of isotopologues. It is determined, using the comparison, whether the hydrocarbons present in the sample have escaped from a subsurface accumulation, thereby determining a presence of the subsurface accumulation.

According to disclosed methodologies and techniques, A computer system is provided that is configured to determine a presence and location of a subsurface hydrocarbon accumulation from a sample of naturally occurring substance. The computer system includes a processor and a tangible, machine-readable storage medium that stores machine-readable instructions for execution by the processor. The machine-readable instructions include: code for determining an expected concentration of isotopologues of a hydrocarbon species; code for modeling, using high-level ab initio calculations, an expected temperature dependence of isotopologues present in the sample; code for measuring a clumped isotopic signature of the isotopologues present in the sample; code for comparing the clumped isotopic signature with the expected concentration of isotopologues; and code for determining, using said comparison, whether hydrocarbons present in the sample originate directly from a source rock or whether the hydrocarbons present in the sample have escaped from a subsurface accumulation.

According to still more disclosed methodologies and techniques, a method of determining a presence and location of a subsurface hydrocarbon accumulation and the origin of associated hydrocarbons collected from a surface seep is provided. According to the method, molecular modeling is integrated to determine the expected concentration of isotopologues from a hydrocarbon species of interest. A concentration of the isotopologues of the hydrocarbon species of interest is measured. Statistical regression analysis is conducted to converge on a temperature-dependent equilibrium constant and an isotopic signature unique to the absolute concentrations measured for multiple co-existing isotopologues. For the hydrocarbons collected from the surface seep, at least one of storage temperature, a source facies, and thermal maturity of source rock associated therewith is determined.

These and other features and advantages of the present disclosure will be readily apparent upon consideration of the following description in conjunction with the accompanying drawings.

### BRIEF DESCRIPTION OF THE DRAWINGS

FIG. 1 is a side elevational view of a seafloor;

FIG. 2 is a flow diagram of a method in accordance with disclosed methodologies and techniques;

FIG. 3 is a graph of isotopologue concentration versus temperature;

FIG. 4 is a block diagram of a computer system according to disclosed methodologies and techniques; and

FIG. 5 is a flow diagram representing machine-readable instructions according to disclosed methodologies and techniques.

### DETAILED DESCRIPTION

Various terms as used herein are defined below. To the extent a term used in a claim is not defined below, it should be given the definition persons in the pertinent art have given that term in the context in which it is used.

As used herein, “a” or “an” entity refers to one or more of that entity. As such, the terms “a” (or “an”), “one or more”, and “at least one” can be used interchangeably herein unless a limit is specifically stated.

As used herein, the terms “comprising,” “comprises,” “comprise,” “comprised,” “containing,” “contains,” “contain,” “having,” “has,” “have,” “including,” “includes,” and “include” are open-ended transition terms used to transition from a subject recited before the term to one or more elements recited after the term, where the element or elements listed after the transition term are not necessarily the only elements that make up the subject.

As used herein, “exemplary” means exclusively “serving as an example, instance, or illustration.” Any embodiment described herein as exemplary is not to be construed as preferred or advantageous over other embodiments.

As used herein “hydrocarbons” are generally defined as molecules formed primarily of carbon and hydrogen atoms such as oil and natural gas. Hydrocarbons may also include other elements or compounds, such as, but not limited to, halogens, metallic elements, nitrogen, oxygen, sulfur, hydrogen sulfide (H₂S) and carbon dioxide (CO₂). Hydrocarbons may be produced from hydrocarbon reservoirs through wells penetrating a hydrocarbon containing formation. Hydrocarbons derived from a hydrocarbon reservoir may include, but are not limited to, petroleum, kerogen, bitumen, pyrobitumen, asphaltenes, tars, oils, natural gas, or combinations thereof. Hydrocarbons may be located within or adjacent to mineral matrices within the earth, termed reservoirs. Matrices may include, but are not limited to, sedimentary rock, sands, silicilytes, carbonates, diatomites, and other porous media.

As used herein, “hydrocarbon production” refers to any activity associated with extracting hydrocarbons from a well or other opening. Hydrocarbon production normally refers to any activity conducted in or on the well after the well is completed. Accordingly, hydrocarbon production or extraction includes not only primary hydrocarbon extraction but also secondary and tertiary production techniques, such as injection of gas or liquid for increasing drive pressure, mobilizing the hydrocarbon or treating by, for example chemicals or hydraulic fracturing the wellbore to promote increased flow, well servicing, well logging, and other well and wellbore treatments.

As used herein the term “isotope” refers to one of two or more atoms with the same atomic number but with different numbers of neutrons. Hydrocarbon molecules may contain a variety of isotopes. Hydrocarbon molecules contain both carbon and hydrogen atoms. Carbon can be present in the molecule as one of two stable isotopes: ¹²C, which has 6 protons and 6 neutrons (shown herein as C); and, in much lower concentrations, ¹³C, which has 6 protons and 7 neutrons. Similarly, hydrogen can be present in a molecule as one of two stable isotopes: H, which contains 1 proton but no neutron; and, in much lower concentrations, Deuterium (D), which has 1 proton and 1 neutron.

As used herein the term “signatures” refers to the relative abundances, concentrations and/or ratios of various elements, isotopes and isotopologues of a given species.

As used herein the term “isotopologue” refers generally to molecules that have the same chemical composition, but have a different isotopic signature; for example, methane contains 1 atom of carbon and four atoms of hydrogen. Each atom in the methane structure can contain one of the two stable isotopes of that atom, and as such there are 10 possible isotopologues of methane.

As used herein the term “multiply substituted isotopologue” refers generally to an isotopologue that contains at least two rare isotopes in its structure; for example, a multiply substituted methane isotopologue must contain one ¹³C atom and one D atom, or at least 2 D atoms in the absence of a ¹³C atom.

As used herein the term “clumped isotopologue” refers generally to an isotopologue that contains at least two rare isotopes that share a common chemical bond in its structure; for example, a clumped isotopologue of methane must one ¹³C atom that shares a chemical bond with at least one D atom.

As used herein the term “stochastic distribution” refers generally to a system where the stable isotopes in a given population of molecules are distributed randomly among all possible isotopologues of a given species. This stochastic distribution is the reference frame from which deviations are measured and is used to provide a baseline to identify anomalies that may be associated with secondary isotope exchange processes.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various serially occurring actions, it is to be appreciated that various actions could occur concurrently, substantially in parallel, and/or at substantially different points in time.

In the following section, specific embodiments of the present invention are described in connection with disclosed aspects and techniques. However, to the extent that the following description is specific to a particular aspect, technique, or a particular use, this is intended to be for exemplary purposes only. Accordingly, the invention is not limited to the disclosed aspects and techniques described below, but rather includes all alternatives, modifications, and equivalents falling within the scope of the appended claims.

According to aspects of the disclosed methodologies and techniques, the clumped isotope signature of numerous co-existing isotopologues of hydrocarbons can be used to determine (i) the presence and depth of a subsurface hydrocarbon accumulation, and (ii) through integration with more conventional isotopic and molecular geochemistry techniques, the origin of associated hydrocarbons. With further integration with conventional geophysical techniques such as seismic reflection, the precise location (the depth plus lateral location) of the subsurface hydrocarbon accumulation can be identified.

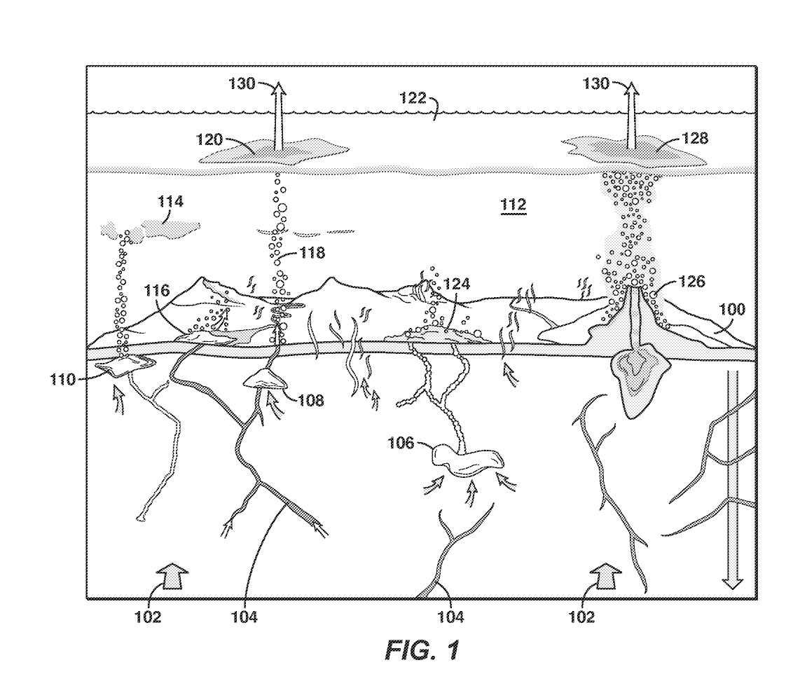

FIG. 1 is a diagram illustrating the numerous subsurface sources and migration pathways of hydrocarbons present at or escaping from seeps on the ocean floor 100. Hydrocarbons 102 generated at source rock (not shown) migrate upward through faults and fractures 104. If limited by subsurface geology the hydrocarbons may be trapped in hydrocarbon accumulations such as a gas reservoir 106, an oil/gas reservoir 108, or a gas hydrate accumulation 110. Hydrocarbons seeping from the gas hydrate accumulation may dissolve into methane in the ocean 112 as shown at 114, or may remain as a gas hydrate on the ocean floor 100 as shown at 116. Alternatively, oil or gas from oil/gas reservoir 108 may seep into the ocean, as shown at 118, and form an oil slick 120 on the ocean surface 122. Gas leaking from gas reservoir 106 may form a bacterial mat 124 that may generate biogenic hydrocarbon gases, which is another sign of seepage. Still another method of hydrocarbon seepage is via a mud volcano 126, which can form an oil slick 128 on the ocean surface. Oil slicks 120 and 128 or methane gas 130 emitted therefrom are signs of hydrocarbon seepage that are, in turn, signs of possible subsurface hydrocarbon accumulation. The signatures measured from each of these seeps may be interrogated according to disclosed methodologies and techniques herein to discriminate between the different origins of hydrocarbons encountered at these seeps. In particular, this invention will discriminate between hydrocarbons that have migrated directly to the surface seep without encountering a structure/seal within which they can be stored (source 1) and hydrocarbons that have escaped from a subsurface accumulation (source 2). If the presence and location of such a hydrocarbon accumulation can be identified, it is possible the hydrocarbons from such an accumulation can be extracted.

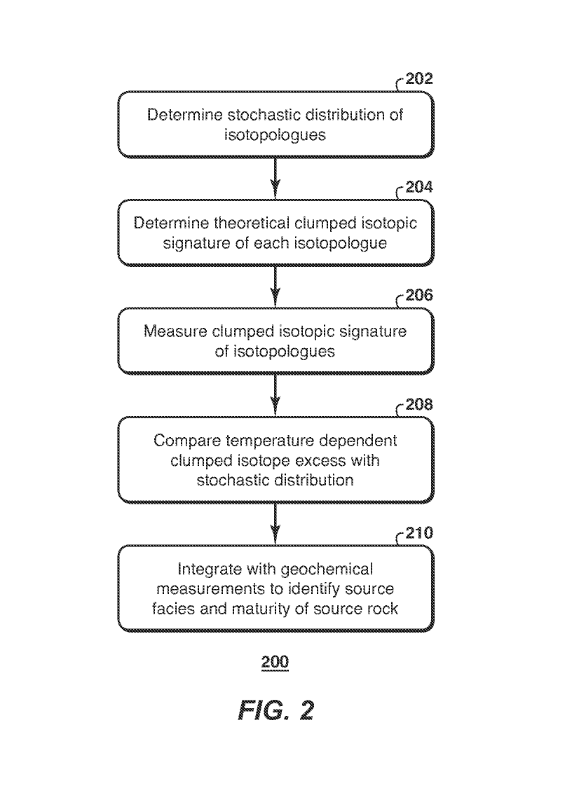

FIG. 2 depicts a flow diagram of a method 200 for determining the (i) location of a subsurface hydrocarbon accumulation, and (ii) the source facies and thermal maturity of associated hydrocarbons sampled from a sea-floor seep. According to the method, at block 202 the stochastic distribution of isotopologues of a hydrocarbon species of interest is determined for a given bulk isotopic signature for that species. Determining the stochastic distribution of isotopologues requires knowledge of the bulk isotope signature of the species from which it derives. For example, if determining the stochastic distribution of isotopologues for methane, calculating the stochastic distribution requires the ¹³C and D signatures of methane. The isotopic signature of hydrocarbon gases that are stored in a subsurface accumulation or that are present at seeps may reflect the isotopic signature of the gas generated from the source rock. As such, this signature may be concomitantly determined during the characterization of the hydrocarbons present at a seep and substituted directly in to the calculation of the stochastic distribution. There may be occasions, however, when the isotopic signature of gases may be altered due to various processes such as mixing with biogenic gas. In such instances, correction schemes such as that proposed by Chung et al., “Origin of gaseous hydrocarbons in subsurface environment: theoretical considerations of carbon isotope distribution”, Chemical Geology, v. 71, p. 97-104 (1988), can be used to deconvolve such contributions and reach the initial primary isotope signature that should be used in the calculation of the stochastic distribution.

At block 204 ab-initio calculations are made to determine the theoretical clumped isotopic signature of each isotopologue of the hydrocarbon of interest. The ab-initio calculations conducted in the molecular modeling focus on a method for calculating the abundances of all isotopologues for any given hydrocarbon in a thermally equilibrated population of isotopologues. This method incorporates three linked algorithms. The first of these algorithms is able to select a subset of the isotopologues of any given species that can uniquely define the bulk isotopic composition of a given population of molecules (for example H/D ratio, including contributions from all isotopologues). The second algorithm is used to define the set of isotopic exchange reactions between all isotopologues for which calculation of an equilibrium constant is required. Finally, the third algorithm is used to calculate the selected equilibrium constants from molecular properties such as molecular mass, rotational constants, vibrational frequencies, anharmonicity corrections and vibration-rotation coupling constants. The latter parameters are calculated using high-level first principle calculations discussed below (e.g. coupled cluster singles, doubles and triples excitation approach using a very large correlation-consistent basis set).

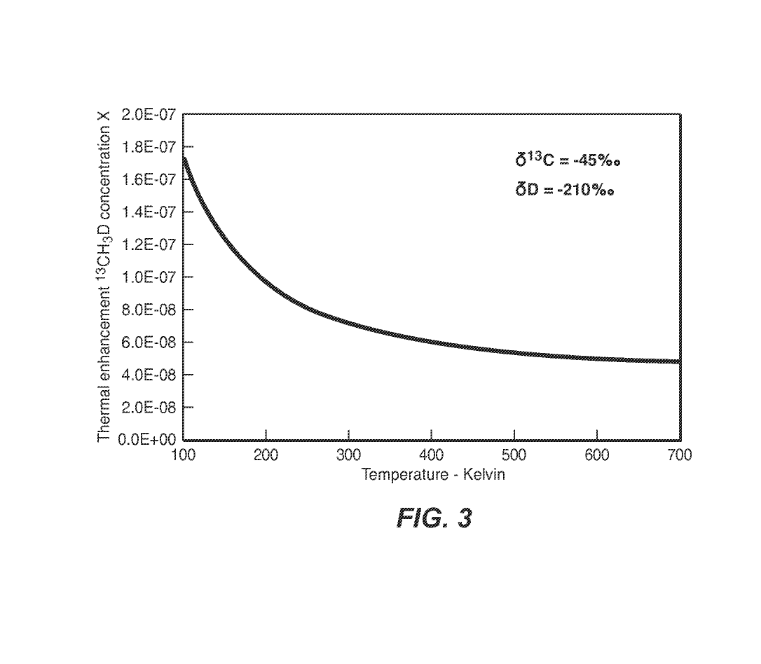

If methane, the primary chemical component of natural gases, is used as an example, it is possible to investigate the potential of forming the clumped doubly substituted isotopologue ¹³CH₃D, and the doubly substituted isotopologue ¹²CH₂D₂. As shown in FIG. 3, in which the thermal enhancement of various concentrations of ¹³CH₃D are plotted versus temperature, the modeled clumped isotope signatures of ¹³CH₃D and ¹²CH₂D₂ vary with temperature. Indeed, it is possible to calculate the thermal dependence for any isotopologue of any hydrocarbon species given the isotopic signature.

If one considers the isotopologue ¹³CH₃D, its total relative abundance in bulk methane should be controlled by (a) temperature-independent randomly populated processes (stochastic distribution) and (b) thermal equilibrium isotopic exchange. The latter process is controlled or dependent on the surrounding temperature. These processes can be determined from first-principle quantum mechanical calculations (such as Couple-cluster Singles Doubles and Triples, CCSD(T) calculations or Density functional theory (DFT)) to investigate the ¹³CH₃D formation, its thermodynamic equilibration and temperature dependence.

The concentration of the doubly-substituted methane isotopologues N[¹³CH₃D]₀ relative to the total methane concentration N[CH4]₀ in a stochastic distribution can be calculated for any given relative concentrations of ¹³C and D (N[¹³C) and N[D)] from equation (1) below:

$${N [ {}_{}^{13}{CH}{}_{3}^{} D ]}_{0} = \frac{N [ {}^{13} C ] N [ D ]}{{N [ {CH}_{4} ]}_{0}} \qquad ( 1 )$$

Any deviation between this modeled concentration and the measured concentration for a given isotopologue (discussed below) is merely a function of the temperature at which the species was stored assuming it reaches isotopic equilibrium for a given temperature over geologic timescales. The temperature dependent isotopic exchange of any species is governed by thermal equilibrium with a known equilibrium constant, K_{eq}(T), and can be described for the examples above by the reaction:

¹³CH₄+CH₃D [symbol] CH₄+¹³CH₃D(K_{eq}) (2)

If the temperature dependent difference between a stochastic and non-stochastic distribution is given by N[¹³CH₃D]_{T}, then following achieving thermal equilibrium, the concentration of the isotopologues involved in equation (2) can be described by the following equations.

N[¹³CH₃D]=N[¹³CH₃D]₀+N[¹³CH₃D]_{T} (3)

N[¹³CH₄]=N[¹³C]—N[¹³CH₃D]_{T} (4)

N[CH₃D]═N[D]-N[¹³CH₃D]_{T} (5)

N[CH₄]═N[CH₄]₀—(N[¹³CH₄]—N[¹³CH₃D]_{T}]-(N[D]-N[¹³CH₃D]_{T})-N[D]-(N[¹³CH₃D]₀+N[¹³CH₃D]_{T}) (6)

From equations (3)-(6) it is possible to describe an equilibrium constant for the initial reaction given in equation (2). The equilibrium constant can then be calculated for any given temperature from high-level quantum chemical calculations and using the Urey Model from partition function of products and reactants.

The total abundance of N[¹³CH₃D] can therefore be calculated from knowledge of K_{eq}(T), N[¹³C] and N[D], combining statistical and thermal equilibrium effects at any given temperature.

The example described above can be applied to determine the expected abundance of any isotopologue on which measurements can be made where the error associated with the measurement does not exceed the deviation from a purely stochastic distribution for a given temperature and primary bulk isotopic signature of the hydrocarbon species of interest.

Returning to FIG. 2, at block 206 the clumped isotopic signature of the isotopologues of the hydrocarbons of interest is measured. The measurement of the absolute abundance of isotopologues for any given hydrocarbon requires knowledge of the molecular mass at which they are present, and hence requires knowledge of the actual identity of each possible isotopologue for that species. Measurement of the abundance of each isotopologue can be conducted using multiple techniques such as mass spectrometry and/or laser-based spectroscopy.

At block 208 the temperature-dependent clumped isotope excess is compared with the previously determined stochastic distribution. Following measurement of the absolute abundance of co-existing isotopologues, it should be possible to integrate the modeled temperature dependence of isotopologues with the measured concentrations to (1) differentiate between hydrocarbons that originate directly from a source rock from those that have escaped from a subsurface accumulation, and (2) determine the current equilibrium storage temperature of the species in the reservoir prior to escape to the surface.

The differentiation between direct seepage from a source rock from the leakage of hydrocarbons from a subsurface accumulation requires consideration of the clumped isotopic signatures that may result from the two models of seepage. Hydrocarbons that have migrated directly from a source rock may either (i) retain a stochastic clumped isotope signature given insufficient time for a thermal contribution to the “clumping” of multiply substituted isotopologues, or (ii) display an inconsistent clumped isotope signature that arises as a result of the variability in the rate of isotope exchange of individual isotopologues. In contrast, hydrocarbons that derive from a subsurface accumulation will retain a clumped isotope signature that more consistently reflects the temperature at which they were stored in the subsurface. This non-kinetic control on the isotopic exchange reactions in isotopologues of hydrocarbons that originate from a subsurface accumulation arises as a result of the inherently long residence times of hydrocarbons in the subsurface. Aspects of the disclosed methodologies and techniques may thereby identify the presence of subsurface hydrocarbon accumulations. Once identified, it is possible to apply a suitable geothermal gradient to the equilibrium storage temperature to estimate the location (depth) within the subsurface that the associated hydrocarbon accumulation resides.

Another aspect of disclosed methodologies and techniques is characterizing the source rock from which the hydrocarbon originated. As represented by block 210, the results of previous portions of the method are integrated with known geochemical proxies that can be concomitantly used to determine the source facies by assessing the biomarker distribution of associated hydrocarbons and thermal maturity estimates through isotopic characterization of associated hydrocarbons. More specifically, from knowledge of the biomarker distribution of different organic matter sources and how this can be genetically linked to the hydrocarbons that are produced from such sources, it is possible to determine the source facies from which the accumulated hydrocarbon derived. In addition to this, from knowledge of how the isotopic signature of hydrocarbons from differently sourced organic matter evolves during maturation, it is possible to determine the thermal maturity of the source rock from which the hydrocarbons derive. The results of the method 200 may also be integrated with conventional exploration or prospect assessment technologies to confirm or de-risk the presence and/or location of a hydrocarbon accumulation and to assess potential migration pathways from the source rock to the seep. Such technologies may include reflection seismic, high resolution seismic imaging, acoustic, basin modeling, and/or probabilistic or statistical assessments. By integrating these technologies, various characteristics of the accumulation may be estimated, such as hydrocarbon volume, hydrocarbon type (e.g., oil vs. gas), and the like. Once a hydrocarbon accumulation has been identified and located, the hydrocarbons therein may be extracted or otherwise produced using known principles of hydrocarbon management.

An alternative to concomitantly determine the reservoir temperature, source facies, and thermal maturity may involve statistical regression analysis to converge on the temperature dependent equilibrium constant and uncommon isotopes, such as ¹³C and D that may be unique to the relative concentrations reported for multiple co-existing isotopologues.

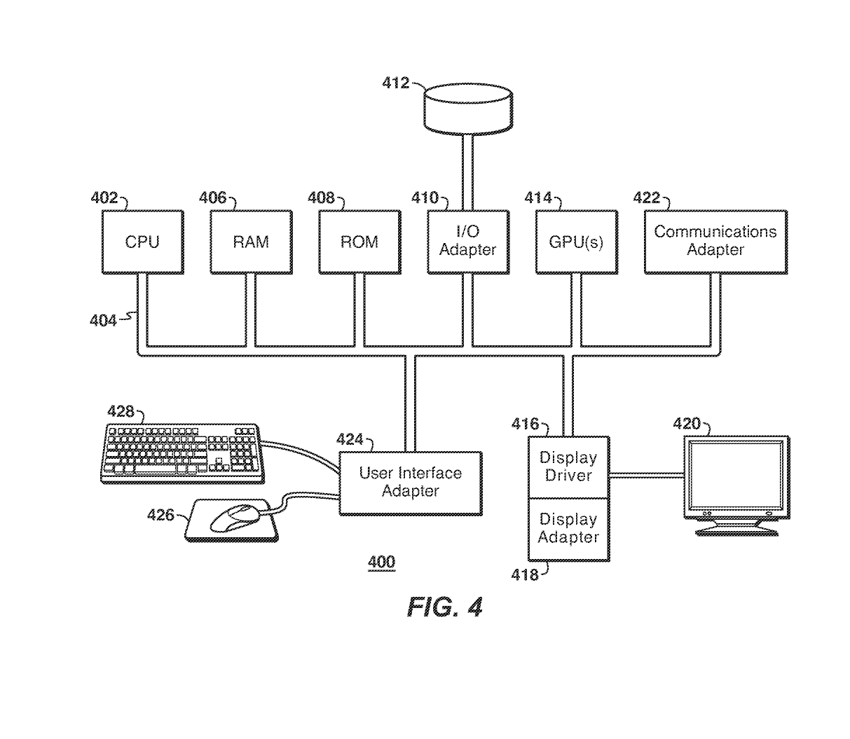

FIG. 4 is a block diagram of a computer system 400 that may be used to perform some or all of the disclosed aspects and methodologies. A central processing unit (CPU) 402 is coupled to system bus 404. The CPU 402 may be any general-purpose CPU, although other types of architectures of CPU 402 (or other components of exemplary system 400) may be used as long as CPU 402 (and other components of system 400) supports the inventive operations as described herein. The CPU 402 may execute the various logical instructions according to various exemplary embodiments. For example, the CPU 402 may execute machine-level instructions for performing processing according to the operational flow described above. One or more Graphics Processing Units (GPU) 414 may be included and used as known in the art.

The computer system 400 may also include computer components such as a random access memory (RAM) 406, which may be SRAM, DRAM, SDRAM, or the like. The computer system 400 may also include read-only memory (ROM) 408, which may be PROM, EPROM, EEPROM, or the like. RAM 406 and ROM 408 hold user and system data and programs, as is known in the art. The computer system 400 may also include an input/output (I/O) adapter 410, a communications adapter 422, a user interface adapter 424, and a display adapter 418. The I/O adapter 410, the user interface adapter 424, and/or communications adapter 422 may, in certain embodiments, enable a user to interact with computer system 400 in order to input information.

The I/O adapter 410 preferably connects a storage device(s) 412, such as one or more of hard drive, compact disc (CD) drive, floppy disk drive, tape drive, etc. to computer system 400. The storage device(s) may be used when RAM 406 is insufficient for the memory requirements associated with storing data for operations of embodiments of the present techniques. The data storage of the computer system 400 may be used for storing information and/or other data used or generated as disclosed herein. The communications adapter 422 may couple the computer system 400 to a network (not shown), which may enable information to be input to and/or output from system 400 via the network (for example, the Internet or other wide-area network, a local-area network, a public or private switched telephony network, a wireless network, any combination of the foregoing). User interface adapter 424 couples user input devices, such as a keyboard 428, a pointing device 426, and the like, to computer system 400. The display adapter 418 is driven by the CPU 402 to control, through a display driver 416, the display on a display device 420. Information and/or representations pertaining to a portion of a supply chain design or a shipping simulation, such as displaying data corresponding to a physical or financial property of interest, may thereby be displayed, according to certain exemplary embodiments.

The architecture of system 400 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

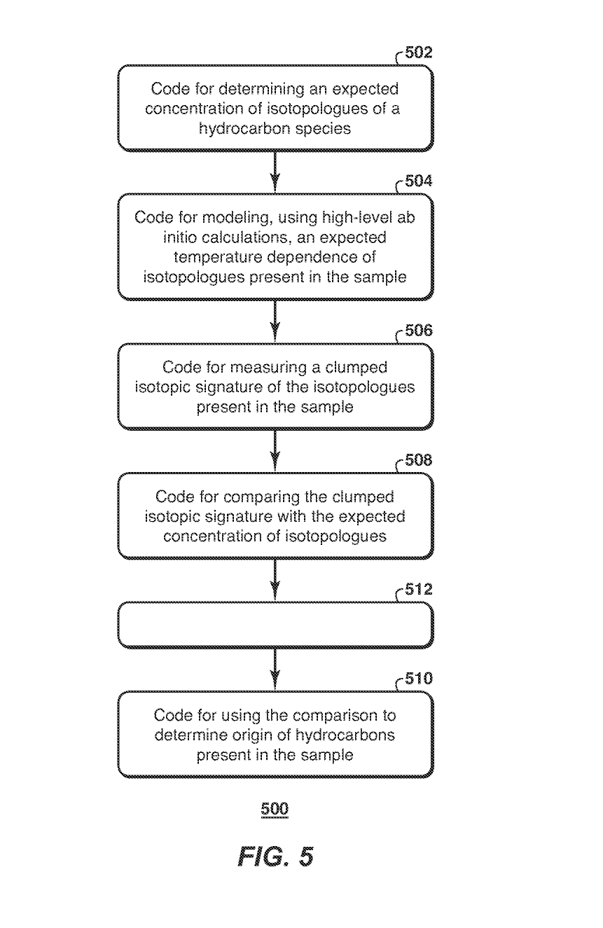

FIG. 5 shows a representation of machine-readable logic or code 500 that may be used or executed with a computing system such as computing system 400. At block 502 code is provided for determining an expected concentration of isotopologues of a hydrocarbon species. At block 504 code is provided for modeling, using high-level ab initio calculations, an expected temperature dependence of isotopologues present in the sample. At block 506 code is provided for measuring a clumped isotopic signature of the isotopologues present in the sample. At block 508 code is provided for comparing the clumped isotopic signature with the expected concentration of isotopologues. At block 510 code is provided for using said comparison to determine whether hydrocarbons present in the sample originate directly from a source rock or whether the hydrocarbons present in the sample have escaped from a subsurface accumulation. When executed or applied with a computer system such as computer system 400, such code is configured to determine the presence and location of a subsurface hydrocarbon accumulation from a sample of naturally occurring substance. Code effectuating or executing other features of the disclosed aspects and methodologies may be provided as well. This additional code is represented in FIG. 5 as block 512, and may be placed at any location within code 500 according to computer code programming techniques.

Illustrative, non-exclusive examples of methods and products according to the present disclosure are presented in the following non-enumerated paragraphs. It is within the scope of the present disclosure that an individual step of a method recited herein, including in the following enumerated paragraphs, may additionally or alternatively be referred to as a “step for” performing the recited action.

A. A method of determining a presence and location of a subsurface hydrocarbon accumulation from a sample of naturally occurring substance, the method comprising:

determining an expected concentration of isotopologues of a hydrocarbon species;

modeling, using high-level ab initio calculations, an expected temperature dependence of isotopologues present in the sample;

measuring a clumped isotopic signature of the isotopologues present in the sample;

comparing the clumped isotopic signature with the expected concentration of isotopologues;

determining, using said comparison, whether hydrocarbons present in the sample originate directly from a source rock or whether the hydrocarbons present in the sample have escaped from a subsurface accumulation;

determining the current equilibrium storage temperature of the hydrocarbon species in the subsurface accumulation prior to escape to the surface; and

determining a location of the subsurface accumulation.

A1. The method in paragraph A, wherein determining an expected concentration of isotopologues includes determining a stochastic distribution of isotopologues of the hydrocarbon species for a given bulk isotopic signature for the species.
A2. The method in any of the preceding paragraphs A-A1, further comprising:
where the given bulk isotopic signature of the hydrocarbon species has been altered from secondary isotope exchange processes or from mixing, applying a correction scheme to arrive at an initial primary isotopic signature representative of what was produced from the source rock.
A3. The method in any of the preceding paragraphs A-A2, wherein the location comprises a depth.
A4. The method in any of the preceding paragraphs A-A3, wherein determining a location includes applying a thermal gradient to an equilibrium storage temperature of the subsurface accumulation.
A5. The method in any of the preceding paragraphs A-A4, further comprising determining a source facies from which hydrocarbons in the subsurface accumulation derived.
A6. The method in any of the preceding paragraphs A-A5, wherein determining a source facies includes genetically linking biomarker distribution of organic matter sources to hydrocarbons produced from the source facies.
A7. The method in any of the preceding paragraphs A-A6, further comprising determining a thermal maturity of the source rock from which hydrocarbons in the subsurface accumulation derive.
A8. The method in any of the preceding paragraphs A-A7, wherein determining a thermal maturity includes using knowledge of how isotopic signature of hydrocarbons from differently sourced organic matter evolves during maturation.
A9. The method in any of the preceding paragraphs A-A8, further comprising determining a precise location of the subsurface hydrocarbon accumulation using a geophysical imaging technique.
A10. The method in any of the preceding paragraphs A-A9, wherein the geophysical imaging technique is seismic reflection.
B. A method of determining a presence and location of a subsurface hydrocarbon accumulation, comprising:

obtaining a hydrocarbon sample from a seep;

analyzing the hydrocarbon sample to determine its geochemical signature, said analyzing including measuring a distribution of isotopologues for a hydrocarbon species present in the hydrocarbon sample;

determining a stochastic distribution of the isotopologues for the hydrocarbon species;

determining a deviation of the measured distribution of isotopologues from the stochastic distribution of the isotopologues for the hydrocarbon species;

determining an origin of the hydrocarbon sample;

determining a storage temperature of the hydrocarbon species when the origin of the hydrocarbon sample is a hydrocarbon accumulation; and

from the storage temperature, determining the location of the hydrocarbon accumulation.

B1. The method in paragraph B, wherein the geochemical signature comprises one or more of bulk composition, isotopic signatures, molecular geochemistry, and clumped isotope/isotopologue chemistry.

B2. The method in any of the preceding paragraphs B-B1, wherein the hydrocarbon species is methane.

B3. The method in any of the preceding paragraphs B-B2, wherein the location of the hydrocarbon accumulation includes a depth.
B4. The method in any of the preceding paragraphs B-B3, wherein the origin of the hydrocarbon sample is a source facies.
B5. The method in any of the preceding paragraphs B-B4, further comprising identifying a source facies associated with the hydrocarbon sample.
B6. The method in any of the preceding paragraphs B-B5, further comprising determining a thermal maturity of a source rock associated with the hydrocarbon sample.
B7. The method in any of the preceding paragraphs B-B6, further comprising confirming the presence and location of the hydrocarbon accumulation using one or more of the following: reflection seismic, acoustic, probabilistic assessments of the presence and location of the hydrocarbon accumulation, and a basin model.
B8. The method in any of the preceding paragraphs B-B7, further comprising producing hydrocarbons from the subsurface accumulation.
C. A method of determining a presence of a subsurface hydrocarbon accumulation from a sample of naturally occurring substance, the method comprising:

determining an expected concentration of isotopologues of a hydrocarbon species;

modeling, using high-level ab initio calculations, an expected temperature dependence of isotopologues present in the sample;

measuring a clumped isotopic signature of the isotopologues present in the sample;

comparing the clumped isotopic signature with the expected concentration of isotopologues;

determining, using said comparison, whether the hydrocarbons present in the sample have escaped from a subsurface accumulation, thereby determining a presence of the subsurface accumulation.

C1. The method in paragraph C, further comprising:

determining the current equilibrium storage temperature of the hydrocarbon species in the subsurface accumulation prior to escape to the surface; and

determining a location of the subsurface accumulation.

D. A computer system configured to determine a presence and location of a subsurface hydrocarbon accumulation from a sample of naturally occurring substance, the computer system comprising:

a processor; and

a tangible, machine-readable storage medium that stores machine-readable instructions for execution by the processor, the machine-readable instructions including
code for determining an expected concentration of isotopologues of a hydrocarbon species,
code for modeling, using high-level ab initio calculations, an expected temperature dependence of isotopologues present in the sample,
code for measuring a clumped isotopic signature of the isotopologues present in the sample,
code for comparing the clumped isotopic signature with the expected concentration of isotopologues, and
code for determining, using said comparison, whether hydrocarbons present in the sample originate directly from a source rock or whether the hydrocarbons present in the sample have escaped from a subsurface accumulation.
   D1. The system in paragraph D, wherein the code for determining an expected concentration of isotopologues includes code for determining a stochastic distribution of isotopologues of the hydrocarbon species for a given bulk isotopic signature for the species.
   D2. The system in any of the preceding paragraphs D-D1, further comprising code for determining the current equilibrium storage temperature of the hydrocarbon species in the subsurface accumulation prior to escape to the surface.
   D3. The system in any of the preceding paragraphs D-D2, further comprising code for determining a location of the subsurface accumulation by applying a thermal gradient to an equilibrium storage temperature of the subsurface accumulation.
   D4. The system in any of the preceding paragraphs D-D3, further comprising code for determining a source facies from which hydrocarbons in the subsurface accumulation derived.
   E. A method of determining a presence and location of a subsurface hydrocarbon accumulation and the origin of associated hydrocarbons collected from a surface seep, comprising:

integrating molecular modeling to determine the expected concentration of isotopologues from a hydrocarbon species of interest;

measuring a concentration of the isotopologues of the hydrocarbon species of interest;

conducting statistical regression analysis to converge on a temperature-dependent equilibrium constant and an isotopic signature unique to the absolute concentrations measured for multiple co-existing isotopologues; and

for the hydrocarbons collected from the surface seep, determining at least one of storage temperature,

a source facies, and

thermal maturity of source rock associated therewith.

E1. The method in paragraph E, further comprising integrating the at least one of the storage temperature, the source facies, and the thermal maturity of source rock associated with the hydrocarbons collected from the surface seep with pre-drill basin burial history models to calibrate an associated basin model.

The disclosed methodologies and techniques may be susceptible to various modifications and alternative forms, and embodiments discussed herein are non-limiting examples. Indeed, the disclosed methodologies and techniques include all alternatives, modifications, and equivalents falling within the spirit and scope of the appended claims.

What is claimed is:

1. A method of determining a presence and location of a subsurface hydrocarbon accumulation from a sample of naturally occurring substance, the method comprising:
determining an expected concentration of isotopologues of a hydrocarbon species;
modeling, using high-level ab initio calculations, an expected temperature dependence of isotopologues present in the sample;
measuring a clumped isotopic signature of the isotopologues present in the sample;
comparing the clumped isotopic signature with the expected concentration of isotopologues;
determining, using said comparison, whether hydrocarbons present in the sample originate directly from a source rock or whether the hydrocarbons present in the sample have escaped from a subsurface accumulation;
determining the current equilibrium storage temperature of the hydrocarbon species in the subsurface accumulation prior to escape to the surface; and
determining a location of the subsurface accumulation.

2. The method of claim 1, wherein determining an expected concentration of isotopologues includes determining a stochastic distribution of isotopologues of the hydrocarbon species for a given bulk isotopic signature for the species.

3. The method of claim 2, further comprising:
where the given bulk isotopic signature of the hydrocarbon species has been altered from secondary isotope exchange processes or from mixing, applying a correction scheme to arrive at an initial primary isotopic signature representative of what was produced from the source rock.

4. The method of claim 1, wherein the location comprises a depth.

5. The method of claim 2, wherein determining a location includes applying a thermal gradient to an equilibrium storage temperature of the subsurface accumulation.

6. The method of claim 1, further comprising determining a source facies from which hydrocarbons in the subsurface accumulation derived.

7. The method of claim 6, wherein determining a source facies includes genetically linking biomarker distribution of organic matter sources to hydrocarbons produced from the source facies.

8. The method of claim 1, further comprising determining a thermal maturity of the source rock from which hydrocarbons in the subsurface accumulation derive.

9. The method of claim 8, wherein determining a thermal maturity includes using knowledge of how isotopic signature of hydrocarbons from differently sourced organic matter evolves during maturation.

10. The method of claim 1, further comprising determining a precise location of the subsurface hydrocarbon accumulation using a geophysical imaging technique.

11. The method of claim 10, wherein the geophysical imaging technique is seismic reflection.

12. A method of determining a presence and location of a subsurface hydrocarbon accumulation, comprising:
obtaining a hydrocarbon sample from a seep;
analyzing the hydrocarbon sample to determine its geochemical signature, said analyzing including measuring a distribution of isotopologues for a hydrocarbon species present in the hydrocarbon sample;
determining a stochastic distribution of the isotopologues for the hydrocarbon species;
determining a deviation of the measured distribution of isotopologues from the stochastic distribution of the isotopologues for the hydrocarbon species;
determining an origin of the hydrocarbon sample;
determining a storage temperature of the hydrocarbon species when the origin of the hydrocarbon sample is a hydrocarbon accumulation; and
from the storage temperature, determining the location of the hydrocarbon accumulation.

13. The method of claim 12, wherein the geochemical signature comprises one or more of bulk composition, isotopic signatures, molecular geochemistry, and clumped isotope/isotopologue chemistry.

14. The method of claim 12, wherein the hydrocarbon species is methane.

15. The method of claim 12, wherein the location of the hydrocarbon accumulation includes a depth.

16. The method of claim 12, wherein the origin of the hydrocarbon sample is a source facies.

17. The method of claim 12, further comprising identifying a source facies associated with the hydrocarbon sample.

18. The method of claim 12, further comprising determining a thermal maturity of a source rock associated with the hydrocarbon sample.

19. The method of claim 12, further comprising confirming the presence and location of the hydrocarbon accumulation using one or more of the following: reflection seismic, acoustic, probabilistic assessments of the presence and location of the hydrocarbon accumulation, and a basin model.

20. The method of claim 12, further comprising producing hydrocarbons from the subsurface accumulation.

21. A method of determining a presence of a subsurface hydrocarbon accumulation from a sample of naturally occurring substance, the method comprising:
determining an expected concentration of isotopologues of a hydrocarbon species;
modeling, using high-level ab initio calculations, an expected temperature dependence of isotopologues present in the sample;
measuring a clumped isotopic signature of the isotopologues present in the sample;
comparing the clumped isotopic signature with the expected concentration of isotopologues;
determining, using said comparison, whether the hydrocarbons present in the sample have escaped from a subsurface accumulation, thereby determining a presence of the subsurface accumulation.

22. The method of claim 21, further comprising:
determining the current equilibrium storage temperature of the hydrocarbon species in the subsurface accumulation prior to escape to the surface; and
determining a location of the subsurface accumulation.

23. A computer system configured to determine a presence and location of a subsurface hydrocarbon accumulation from a sample of naturally occurring substance, the computer system comprising:
a processor; and
a tangible, machine-readable storage medium that stores machine-readable instructions for execution by the processor, the machine-readable instructions including
code for determining an expected concentration of isotopologues of a hydrocarbon species,
code for modeling, using high-level ab initio calculations, an expected temperature dependence of isotopologues present in the sample,
code for measuring a clumped isotopic signature of the isotopologues present in the sample,
code for comparing the clumped isotopic signature with the expected concentration of isotopologues, and
code for determining, using said comparison, whether hydrocarbons present in the sample originate directly from a source rock or whether the hydrocarbons present in the sample have escaped from a subsurface accumulation.

24. The system of claim 23, wherein the code for determining an expected concentration of isotopologues includes code for determining a stochastic distribution of isotopologues of the hydrocarbon species for a given bulk isotopic signature for the species.

25. The system of claim 23, further comprising code for determining the current equilibrium storage temperature of the hydrocarbon species in the subsurface accumulation prior to escape to the surface.

26. The system of claim 25, further comprising code for determining a location of the subsurface accumulation by applying a thermal gradient to an equilibrium storage temperature of the subsurface accumulation.

27. The system of claim 23, further comprising code for determining a source facies from which hydrocarbons in the subsurface accumulation derived.

28. A method of determining a presence and location of a subsurface hydrocarbon accumulation and the origin of associated hydrocarbons collected from a surface seep, comprising:
integrating molecular modeling to determine the expected concentration of isotopologues from a hydrocarbon species of interest;
measuring a concentration of the isotopologues of the hydrocarbon species of interest;
conducting statistical regression analysis to converge on a temperature-dependent equilibrium constant and an isotopic signature unique to the absolute concentrations measured for multiple co-existing isotopologues; and
for the hydrocarbons collected from the surface seep, determining at least one of storage temperature,
a source facies, and
thermal maturity of source rock associated therewith.

29. The method of claim 28, further comprising integrating the at least one of the storage temperature, the source facies, and the thermal maturity of source rock associated with the hydrocarbons collected from the surface seep with pre-drill basin burial history models to calibrate an associated basin model.
